(19) United States
(12) Patent Application Publication
(10) Pub. No.: US 2025/0186917 A1
(43) Pub. Date: Jun. 12, 2025

(54) METHOD FOR PRODUCING A FILTER ELEMENT

(71) Applicant: HENGST SE, Muenster (DE)

(72) Inventors: Lars PETERSEN, Muenster (DE); Juergen EFING, Dortmund (DE)

(21) Appl. No.: 18/839,947

(22) PCT Filed: Feb. 17, 2023
(86) PCT No.: PCT/EP2023/054027

§ 371 Date: Aug. 20, 2024

(30) Foreign Application Priority Data
Feb. 21, 2022 (DE) 10 2022 103 995.1

(51) Int. Cl. B01D 46/00; B01D 39/16; B01D 46/52; B01D 53/04; B31D 5/00

(52) U.S. Cl. CPC B01D 46/0001; B01D 39/1623; B01D 46/0032; B01D 46/0036; B01D 46/521; B01D 53/04; B31D 5/0082; B01D 2239/0407; B01D 2239/0435; B01D 2239/0478; B01D 2239/0618; B01D 2239/065; B01D 2239/10; B01D 2253/102; B01D 2275/10

(57) ABSTRACT

A planar first medium in web form is produced or provided, having a first carrier layer including a first nonwoven fabric at least partially coated with an electrically conductive material. A planar second medium in web form is produced or provided, including a second carrier layer that comprises a second nonwoven fabric at least partially coated with an electrically conductive material. The first medium comprises a first filter layer arrangement connected to the first carrier layer, and/or the second medium comprises a second filter layer arrangement connected to the second carrier layer. The first medium and the second medium are amalgamated to obtain a layer composite in web form, such that the first filter layer arrangement and/or the second filter layer arrangement are at least partially arranged between the first carrier layer and the second carrier layer. A portion of the layer composite is separated thereby obtaining a filter element.

The invention relates to a method for producing a filter element and a corresponding filter element as well as a filter comprising the filter element. Also disclosed is a device for carrying out the method.

Modern filtration technology now offers numerous efficient alternatives and further developments to the well-known methods for separating undesirable components from fluid flows, which are mostly based on essentially mechanical separation, usually on a filter element that is only partially permeable and which can, for example, consist of a porous material.

One of these further developments, which is used in particular for gas purification, is the so-called electrostatic separation, wherein the devices used are also referred to as electrostatic separators. In these electrostatic separators, the particles to be removed are ionized by an electrode in a first step and then deposited on an oppositely charged collecting electrode. Corresponding electrostatic separators are used in particular in industrial plants.

However, other requirements are placed on the performance characteristics of cabin air filters, in particular for use in vehicles, wherein, for example, the reliable separation of pollen and/or fine dust and/or odors and/or exhaust gases is also desired.

In order to meet these requirements for cabin air filters, the concept of electrostatic separation, which in many cases is not strictly speaking filtration, has been combined with methods of mechanical separation to obtain high-performance filters. Due to the mostly intrinsic electrostatic charge of many filter materials used in the field of filtration, for example typical nonwoven materials, in particular so-called electret materials, the separation performance of filters can in many cases be significantly increased by combining them with an ionization device. However, with corresponding filter arrangements it has been observed that the separation efficiency can decrease over the service life of the filter arrangement, which is often attributed to a reduced electrostatic charge in the filter material over time.

To solve this problem, filter elements have been proposed which have two electrically conductive layers in the layered material, separated from one another by an insulating material, with which a polarization of the filter material can be caused in the filter element by applying a voltage via the creation of an electric field, which in combination with an ionization device enables efficient separation, which can advantageously be preserved over the entire service life of the filter element in most cases. Examples of corresponding filter elements as well as further background information on the basic technology are disclosed, for example, in WO 2007/135232 A1 or EP 3 448 540 B1.

However, despite the potentially advantageous properties, the production of corresponding polarizable filter elements for electrostatic separators proves to be very challenging in practice. To ensure correct functioning, it must be ruled out that the two layers acting as electrodes in the filter element come into contact with one another, which is regularly made more difficult by the fact that the layered filter elements usually have to be folded for use in order to obtain a so-called pleated filter element.

The application of the necessary electrodes, via which the voltage can be applied to the two layers in the filter element that act as electrodes, also poses a challenge.

The problems described above are particularly serious in the field of large-scale production of such filter elements, i.e. in the field of mass production, as is required in particular for supplying the automotive industry. When attempting to implement this on a large scale, a particular disadvantage is that for the continuous production of filter elements from starting materials in web form, which would be preferred in view of the achievable production capacities and process control, the filter elements inevitably have to be separated from the layer structure in strand or web form. However, due to the methods used, such as cutting, hot cutting or ultrasonic welding, this so-called cutting to length of the layer structure in web form causes mechanical and/or thermal stress on the material in the cutting area, which can lead, for example, to compression of the filter medium and/or fusion of the layers. Due to this circumstance, there is a high probability that a short circuit will occur between the conductive layers during the large-scale production of such filter elements or that such a short circuit will occur as a result of the stress experienced during subsequent use. However, a high level of waste in production or a high failure rate in use are in many cases exclusion criteria for applications in the automotive sector, for example, since vehicle manufacturers are typically very cost-sensitive and the industry is characterized by high quality expectations. In this respect, to the best of the inventors' knowledge, the state of the art also lacks solutions for the large-scale production of corresponding filter elements.

The problem of unwanted contact between the conductive layers described above exists in particular if the conductive layers are to be formed using coated nonwovens made of, mostly thermoplastic, plastics, which, however, according to the inventors' findings, is particularly advantageous with regard to the weight of the filter element, the production costs and the achievable filter performance, since these materials are easily mechanically deformable and often comprise thermoplastic materials.

The primary object of the present invention was to eliminate or at least mitigate the disadvantages of the prior art described above.

In particular, it was an object of the present invention to provide a method for producing filter elements for use in electrostatic separators, with which corresponding filter elements can also be produced on a large scale, in particular within the scope of continuous or at least semi-continuous methods.

In particular, however, it was also an object of the present invention to provide a filter element for use in electrostatic separators which is particularly efficient and at the same time mechanically very resilient and with which, in combination with an ionization device in filters, particularly good separation performance can be achieved.

In the interaction of the two objects described above, it was a particular object of the present invention to optimally match the advantageous method to be specified to the advantageous filter elements to be specified and vice versa. It was therefore an object of the present invention to resolve the conflicting objectives of pure optimization of the separation performance and producibility in large-scale methods for the filter elements to be specified and at the same time to design the method to be specified in such a way that it is compatible with technical specifications resulting from the specific structure of the filter elements to be specified.

It was a further object of the present invention that the method to be specified should be feasible in the most time- and cost-efficient manner possible, while ideally ensuring a high level of operational reliability, desirably with simultaneous low production of offcuts and other waste.

It was a supplementary object of the present invention that the filter elements to be specified should be particularly mechanically resilient and should not show any undesirable delamination during production, in particular during folding, but also during subsequent operation in the vehicle. Insofar, it was a further object of the present invention that the filter elements to be specified exhibit an extended replacement interval compared to the prior art, wherein in particular the filter performance with respect to particles should ideally remain largely constant until the end of the replacement interval. In addition, it was a supplementary object that the filter elements to be specified should be particularly light and thin in order to be able to save space and weight.

It was a secondary object of the present invention to specify a filter which comprises the filter element to be specified. In addition, it was a secondary object of the present invention to specify a device which is suitable for carrying out the method according to the invention.

The above-mentioned objects are thus achieved by the subject matter of the invention as defined in the claims. Preferred designs according to the invention are apparent from the dependent claims and the following embodiments.

Such embodiments, which are hereinafter designated as preferred, are combined in particularly preferred embodiments with features of other embodiments designated as preferred. Combinations of two or more of the embodiments referred to below as particularly preferred are thus very particularly preferred. Also preferred are embodiments in which a feature of one embodiment designated as preferred to any extent is combined with one or more other features of other embodiments designated as preferred to any extent. Features of preferred filter elements, filters and devices result are derived from the features of preferred methods.

The invention relates to a method for producing a filter element, in particular for use in electrostatic separators, comprising the method steps:
a) producing or providing a planar first medium in web form, containing a first carrier layer, having a first carrier layer that comprises a first nonwoven at least partially coated with an electrically conductive material, and producing or providing a planar second medium in web form, having a second carrier layer that comprises a second nonwoven at least partially coated with an electrically conductive material, wherein the first medium comprises a first filter layer arrangement connected to the first carrier layer, and/or wherein the second medium comprises a second filter layer arrangement connected to the second carrier layer,
b) amalgamating the first medium and the second medium to obtain a layer composite in web form, the amalgamation taking place such that the first filter layer arrangement and/or the second filter layer arrangement are at least partially arranged between the first carrier layer and the second carrier layer, and
c) separating a portion of the layer composite in web form in order to obtain the filter element comprising a part of the first carrier layer and the second carrier layer and comprising the first filter layer arrangement and/or the second filter layer arrangement,
wherein the amalgamation in method step b) comprises one of the following steps:
b1) applying the second medium in web form to the first medium in web form, wherein the second carrier layer comprises a plurality of coating areas spaced apart from one another along the web direction of the layer composite, in which the second nonwoven is coated with the electrically conductive material, or
b2) dividing the second medium in web form to obtain a plurality of sub-areas, the amalgamation taking place such that the sub-areas are spaced apart from one another along the web direction of the layer composite, wherein the second nonwoven of the second carrier layer is at least partially coated with the electrically conductive material in the sub-areas, and
wherein separating the portion from the layer composite in web form in method step c) is carried out in such a way that the separating line runs between two adjacent coating areas or two adjacent sub-areas.

The method according to the invention serves to produce filter elements which, due to their structure, make it possible to bring about a distribution of the electrical charge in the filter element (polarization) by applying an electrical voltage and which consequently have an improved separation effect of charged particles, such as can be generated in particular by an ionization device. In other words, the filter element is thus in particular designed to cause or promote the separation of electrically charged particles, in particular ionized particles, when an electrical voltage is applied to the first carrier layer and the second carrier layer, in particular the electrically conductive coated area of the first carrier layer and the second carrier layer.

The performance of the filter elements that can be produced using the method according to the invention is particularly evident in the field of automotive applications. Accordingly, a method according to the invention is also preferred, wherein the filter element is an air filter, preferably a cabin air filter, particularly preferably a cabin air filter for vehicles.

The method according to the invention is designed so that filter elements according to the invention can be produced in a substantially continuous method and/or in large quantities, while at the same time avoiding characteristic production defects. Accordingly, it is also preferred to operate the method according to the invention in this manner. Therefore, a method according to the invention is preferred, wherein the method is a continuous or semi-continuous method, preferably a continuous method.

In view of the quantities that can be produced, it is advantageous to automate the method as much as possible. Against this background, a method according to the invention is preferred, wherein the method is operated at a production rate of 2 or more, preferably 50 or more, particularly preferably 200 or more, filter elements per hour.

Continuous or semi-continuous method management can be realized particularly well if the media used are provided via material rolls from which the media, apart from the occasional exchange of empty material rolls, can be continuously provided and, for example, guided through the devices used at a continuous feed rate, for example on a conveyor belt. Accordingly, a method according to the invention is preferred, wherein the first medium and/or the second medium, preferably both media each, are provided on a material roll. Additionally or alternatively, a method according to the invention is preferred, wherein the first medium is guided on a support, wherein the support is preferably a conveying device which conveys the first medium particularly preferably continuously through the device used, wherein the second medium is preferably arranged on the guided first medium during amalgamating.

In a first step, at least two planar media in web form are provided. In accordance with the understanding of the person skilled in the art, planar elements have significantly larger dimensions in two spatial directions than in the third spatial direction. Planar elements in web form have a significantly greater extension in one of the spatial directions in the plane than in the other. Examples of planar elements in web form are, in particular, fabric webs or metal sheets, which can typically be stored on rolls.

The above definition of method step a) means that the first medium and the second medium must each have a carrier layer and that, in addition, there is at least one filter layer arrangement which comprises the further layers of the desired composite, wherein this can, however, be part of the first medium or part of the second medium, wherein it is also conceivable that both media comprise a filter layer arrangement, i.e. comprise further layers in addition to the carrier layer. However, in particular in the case of a method management with step b2), which comprises dividing the second medium in web form as described below, it is advantageous according to the assessment of the inventors if the filter layer arrangement is provided largely or even completely in the first medium, since this simplifies the processing of the second medium and minimizes the risk of damage to the filter layer arrangement which could occur during dividing. Consequently, a method according to the invention is preferred, wherein the first medium comprises the first filter layer arrangement and/or wherein the second medium consists of the second carrier layer.

The two carrier layers each comprise a nonwoven and are therefore designed to be gas permeable. As a result, the carrier layers in the manufactured filter element also serve synergistically as filter layers and contribute to the separation performance. In the filter elements produced, the two carrier layers however also function in particular as conductive layers or electrodes, which cause the polarization of the filter layer arrangement(s) as a result of an applied electrical voltage.

For this purpose, the nonwovens used are at least partially, depending on the method management and medium preferably predominantly or even substantially over the entire surface area, coated with an electrically conductive material, and thus exhibit, based on a mostly non-conductive nonwoven, an increased electrical conductivity, which functionally enables them to be used as electrodes. Here, in addition to planar coatings, the required functionality can also be achieved by a patterned coating, as described below.

In principle, the carrier layers can also comprise other components in addition to the nonwoven, such as reinforcing elements. However, with a view to cost-efficient production and the desired weight reduction, it is preferred in each case if the carrier layers consist substantially of the respective nonwoven. Consequently, a method according to the invention is preferred, wherein the first carrier layer consists of the first nonwoven at least partially coated with an electrically conductive material, and/or wherein the second carrier layer consists of the second nonwoven at least partially coated with an electrically conductive material.

In this respect, the term “coated” is to be interpreted broadly within the scope of the understanding of the person skilled in the art and comprises all forms of coating the nonwoven with the conductive material, even if this coating may comprise inclusions of electrically conductive material which are mechanically immobilized in the open-pored structure of the nonwoven. The person skilled in the art understands that what is functionally important is the increased electrical conductivity achieved by the coating as a result of the treatment with the conductive material and that it is therefore not necessary to characterize the exact nature of the interaction between the nonwoven acting as a substrate and the electrically conductive material. However, a method according to the invention is generally preferred, wherein the first nonwoven and/or the second nonwoven, preferably the first nonwoven and the second nonwoven, are coated with the electrically conductive material in a method which is selected from the group consisting of impregnation, dip coating, spray coating or pressure coating.

In practice, the person skilled in the art makes the distinction between an electrically conductive material and an electrically insulating material unconstrained and on the basis of their skilled and clear technical understanding of these terms. In this respect, within the scope of the present invention, a material is considered to be an electrically conductive material in particular if its specific electrical resistance at 20° C. is 1000 Ωmm²/m or less, preferably 100 Ωmm²/m or less, particularly preferably 10 Ωmm²/m or less. Conversely, within the scope of the present invention, a material is considered to be an electrically insulating material in particular if its specific electrical resistance at 20° C. is 10⁸ Ωmm²/m or more, preferably 10¹⁰ Ωmm²/m or more, particularly preferably 10¹² Ωmm²/m or more. Accordingly, metals and alloys, but also carbon blacks and plastics made conductive by additives, such as conductive carbon black in particular, are electrically conductive materials, whereas typical plastics such as PET or PE are also electrically insulating materials, as are glasses and ceramics, for example. According to the inventors' assessment, a method according to the invention is preferred, wherein the electrically conductive material of the first nonwoven and/or the second nonwoven, preferably of both nonwovens, is selected from the group consisting of metals, conductive plastics and carbon, preferably carbon, in particular carbon black, wherein the electrically conductive material is particularly preferably identical for all nonwovens.

In practice, the extent to which the second carrier layer is coated depends primarily on the design of method step b). For the first carrier layer, however, it is particularly preferable in terms of simplicity of production if it is comprehensively coated. A method according to the invention is therefore preferred, wherein the first nonwoven of the first carrier layer is coated with the electrically conductive material over 80% or more of the surface area, preferably over 90% or more, particularly preferably over 95% or more, very particularly preferably over 98% or more, particularly preferably substantially over the entire surface area. In other words, a method according to the invention is preferred, wherein the first carrier layer, as a result of the coating of the first nonwoven, is electrically conductive over at least 80% or more of the surface area, preferably over 90% or more, particularly preferably over 95% or more, very particularly preferably over 98% or more, particularly preferably substantially over the entire surface area. A particularly relevant alternative design of the first nonwoven of the first carrier layer, which does not use a planar coating, is considered to be the coating with a coating pattern, as further disclosed below.

The first and/or second filter layer arrangement provide the layer by which the two carrier layers in the filter element are separated. With regard to the achievable filter performance and the low weight, it is considered particularly advantageous if the filter layer arrangement comprises or consists of an electrically insulating nonwoven. A method according to the invention is preferred, wherein the first filter layer arrangement and/or the second filter layer arrangement, preferably the first filter layer arrangement, comprise a first filter layer, wherein the first filter layer comprises an electrically insulating third nonwoven. A structure in which the produced filter element comprises such a first filter layer between the carrier layers is preferred for all embodiments.

The inventors have found that particularly efficient filter elements can be obtained if at least one layer is provided in the filter layer arrangement(s) which consists predominantly of activated carbon and by means of which excellent performance properties can be achieved in the filtration of gas phases. In this respect, with regard to the mechanical resilience and in particular with regard to the mass-related separation performance, it was identified as advantageous if this activated carbon layer in particular does not contain any fibrous components or other fillers that do not contribute to the adsorption properties of the activated carbon layer. By using the method according to the invention and in filter elements according to the invention, it is advantageously not necessary, unlike in some filter elements of the prior art, for the activated carbon layer to contribute to the conductivity of the outer layers, which, according to the assessment of the inventors, often only works insufficiently well anyway. This allows the adsorption properties of the activated carbon layer to be advantageously brought to the fore. Against this background, a method according to the invention is particularly preferred, wherein the first filter layer arrangement and/or the second filter layer arrangement, preferably the first filter layer arrangement, comprise a second filter layer, wherein the second filter layer comprises activated carbon, preferably particulate activated carbon, in a mass fraction of 70% or more, preferably 80% or more, particularly preferably 90% or more, particularly preferably 95% or more, based on the mass of the second filter layer. Additionally or alternatively, a method according to the invention is preferred, wherein the second filter layer comprises a mass fraction of less than 1%, preferably less than 0.1%, particularly preferably less than 0.01% of fibrous materials. With regard to the selection of the activated carbon, a method according to the invention is preferred, wherein the activated carbon has a specific surface of 500 m²/g or more, preferably of 1,000 m²/g or more, particularly preferably of 2,000 m²/g or more. A structure in which the produced filter element comprises such a second filter layer between the carrier layers is preferred for all embodiments, wherein the combination with a first and a second filter layer is considered to be particularly favorable.

It can be considered an advantage of the method according to the invention and of the filter elements according to the invention that they are very flexible with regard to the presence of further layers in the filter layer arrangements and their arrangement in the composite. With the method according to the invention, additional layers and protective layers which support the filtration effect and/or capture certain health-relevant substances can advantageously also be provided in the filter element. In this respect, a method according to the invention is preferred, wherein the first filter layer arrangement and/or the second filter layer arrangement, preferably the first filter layer arrangement, comprise a first additional layer, wherein the first additional layer comprises an electrically insulating fourth nonwoven, wherein the first additional layer is preferably arranged between the first filter layer and the second filter layer. In this respect, a method according to the invention is also preferred, wherein the first filter layer arrangement and/or the second filter layer arrangement, preferably the first filter layer arrangement, comprise a second additional layer, wherein the second additional layer comprises an electrically insulating fifth nonwoven, wherein the second additional layer is preferably arranged between the second filter layer and a carrier layer, particularly preferably the first carrier layer. Additionally or alternatively, a method according to the invention is preferred, wherein the first filter layer arrangement and/or the second filter layer arrangement, preferably the first filter layer arrangement, comprise at least a first protective layer, wherein the first protective layer comprises one or more active ingredients selected from the group consisting of antiallergenic active ingredients and biocidal active ingredients.

In method step b), the first medium and the second medium are connected to one another. This expediently comprises contacting the two media, which can be realized, for example, by a suitable guide arrangement for one or both of the media, wherein one of the two alternative ways of method management, as described below, should be taken into account.

Amalgamating and thus creating the layer composite in web form can in principle be carried out using conventional methods and in the simplest case can even be realized by mechanical interlocking between nonwovens of the contacted media. However, due to the ease of handling and the advantageous adjustable composite strength, a method according to the invention is preferred, wherein amalgamating the first medium with the second medium comprises connecting the first medium to the second medium by means of a material-bonding connection, preferably by means of an adhesive, for example in the edge areas of the layer composite in web form.

According to the invention, amalgamating is carried out such that at least partially one of the filter layer arrangements is arranged between the two carrier layers, so that it is also conceivable that only the first filter layer arrangement is arranged between the carrier layers, whereas a second filter layer arrangement made of the second medium is located on the outside of the composite. However, a method according to the invention is preferred, wherein the amalgamating is carried out such that the first filter layer arrangement and the second filter layer arrangement are at least partially, in the case of step b1) preferably over the entire length of the layer composite in web form, arranged between the first carrier layer and the second carrier layer, so that the first filter layer arrangement and the second filter layer arrangement contact one another. In this case, the first filter layer arrangement and the second filter layer arrangement together form a so-called overall layer arrangement, which comprises the entirety of the layers arranged between the carrier layers and which is further described below with reference to the filter elements according to the invention.

The extent to which the filter layer arrangement(s) are arranged between the carrier layers depends in particular on the method management described below, wherein, in particular in the variant with step b2), areas are formed between the sub-areas of the second medium in which the filter layer arrangement(s) are arranged above the first carrier layer but are not covered by the second carrier layer.

In method step c), the production of the filter elements is then carried out, namely by separating portions from the layer composite in web form, so that the filter element is obtained which comprises the two carrier layers and comprises at least one of the filter layer arrangements therebetween, wherein this separation is carried out with a specific proviso which is described below. According to the inventors' findings, a method according to the invention is preferred, wherein separating the portion of the layer composite in web form is carried out by a method which is selected from the group consisting of cutting, punching and welding methods, preferably shearing, laser cutting and ultrasonic welding. In other words, a method according to the invention is preferred, wherein separating the portion of the layer composite in web form is carried out with a separating device, wherein the separating device is selected from the group consisting of flying knives, punching tools, laser beam cutters and ultrasonic welding devices.

If a pleated filter is to be produced, the folding step can take place before, during or after method step c). A method according to the invention is thus preferred, wherein the filter element is produced as a pleated filter element, wherein, prior to separating the portions, the layer composite in web form is folded at least partially, preferably over the entire length of the portion to be separated, or wherein, after separating, the separated portion of the layer composite in web form is folded at least partially, preferably over the entire length of the separated portion, wherein the folding is particularly preferably carried out using a folding device.

In addition, additional electrodes can be applied before, during or after separating, via which a voltage can be applied to the carrier layers. A method according to the invention is preferred, wherein, prior to separating in method step c), preferably prior to folding the layer composite in web form, one or more electrodes are arranged on the first carrier layer and/or on the second carrier layer, preferably on both carrier layers.

Based on the method as described above, the design of method step b) is of particular importance for the method according to the invention. During the development of the invention, two fundamental alternative solutions for the design of method step b) have emerged, which the person skilled in the art can use to achieve the object. However, according to the assessment of the inventors, these alternative solutions are each associated with additional advantages which, in practice, together with the question of the equipment available to the person skilled in the art, will determine the choice of method design.

In a first embodiment, method step b) may comprise step b1). Here, a specifically designed second medium is used, namely a second medium the carrier layers of which are coated with the electrically conductive material only in portions, the so-called coating areas, wherein these coating areas are spaced apart from one another along the web direction, i.e. along the longitudinal direction of the planar second medium in web form, so that there are intermediate areas arranged between the coating areas which are not electrically conductive.

The shape of the coating areas is expediently matched to the shape of the subsequent filter elements, so that, for example, oblique contours and edges in the filter element can already be anticipated via the coating areas. A method according to the invention is therefore preferred, wherein the shape of the coating areas in the second carrier layer substantially corresponds to the shape of the filter element to be produced. The selective coating of the second carrier layer in the coating areas can be created by spatially resolved coating, preferably by local printing, of the second nonwoven, wherein complex shapes can also be reproduced very efficiently, in particular during printing.

According to the assessment of the inventors, it is sensible to provide a pronounced coating in each of the coating areas and thereby ensure excellent conductivity, as is also disclosed above for the first carrier layer as a whole. A method according to the invention is therefore preferred, wherein in step b1) the second nonwoven of the second carrier layer is coated with the electrically conductive material in the coating areas over 80% or more of the surface area of the coating area, preferably over 90% or more, particularly preferably over 95% or more, very particularly preferably over 98% or more, particularly preferably substantially over the entire surface area. In other words, a method according to the invention is preferred, wherein in step b1) the second carrier layer is electrically conductive as a result of the coating of the second nonwoven at least over 80% or more of the surface area of the coating area, preferably over 90% or more, particularly preferably over 95% or more, very particularly preferably over 98% or more, particularly preferably substantially over the entire surface area. In this respect, the coating areas can in particular also be coated with a coating pattern, wherein the surface areas defined above are covered by the coating pattern, but the actual surface area coverage with the electrically conductive material is lower, in particular 60% or less, preferably 40% or less, particularly preferably 30% or less.

Sensible distances between the coating areas can be specified both in absolute terms and relative to the dimensions of the coating areas. A method according to the invention is preferred, wherein in step b1) the coating areas in the second carrier layer along the web direction of the layer composite each have a distance in the range of 1 to 50 mm, preferably in the range of 3 to 20 mm, from adjacent coating areas, and/or wherein in step b1) the coating areas in the second carrier layer along the web direction of the layer composite each have a distance in the range of 0.01*L to 0.1*L, preferably in the range of 0.02*L to 0.05*L, from adjacent coating areas, where L is the average length of the adjacent coating areas along the web direction of the layer composite.

In a second embodiment, method step b) may comprise step b2). Here, so-called sub-areas are separated from a second medium in web form with a second carrier layer, for example one that is coated with the electrically conductive material over the entire surface area, and are arranged at a distance from one another on the first medium in web form such that in this structure too a layer composite is obtained which has no electrically conductive connection between portions of the second medium which are spatially separated along the web direction.

In principle, dividing can be carried out without waste or with waste by removing a waste area between the sub-areas. In the first case, the spaced arrangement of the sub-areas can expediently be facilitated by different feed speeds of the media in web form, whereas the second method management creates a distance between the sub-areas even at the same feed speed due to the waste area removed. Preferred in this respect is insofar, on the one hand, a method according to the invention, wherein in step b2) dividing the sub-areas of the second medium is carried out such that when dividing between the sub-areas substantially no waste area of the second medium is removed, wherein the division is preferably carried out by a chipless separation process, in particular a cutting process, wherein the spacing of the sub-areas on the first medium in web form is preferably achieved at least partially, particularly preferably substantially completely, by guiding the second medium at a reduced speed and/or with a discontinuous timing, preferably at a reduced speed, relative to the first medium. On the other hand, a method according to the invention is preferred, wherein in step b2) dividing the sub-areas of the second medium is carried out such that when dividing between the sub-areas, a waste area of the second medium is removed, wherein the spacing of the sub-areas on the first medium in web form is at least partially, preferably substantially completely, created by the waste areas, wherein the second medium is preferably guided at substantially the same speed relative to the first medium.

In the design of step b2), a selective coating of the second carrier layer can advantageously be dispensed with. Even if a second carrier layer with coating areas as required for step b1) could at least theoretically be used, it is advantageous, with a view to simple method management and reduced production or storage costs, to use second carrier layers that are coated over their entire surface area when using step b2), which in particular preferred cases can in particular also consist of the same materials as the first carrier layers. Accordingly, a method according to the invention is preferred, wherein in step b2) the second nonwoven of the second carrier layer is coated with the electrically conductive material over 80% or more of the surface area, preferably over 90% or more, particularly preferably over 95% or more, very particularly preferably over 98% or more, particularly preferably substantially over the entire surface area. In other words, a method according to the invention is preferred in this respect, wherein the second carrier layer, as a result of the coating of the second nonwoven, is electrically conductive over at least 80% or more of the surface area, preferably over 90% or more, particularly preferably over 95% or more, very particularly preferably over 98% or more, particularly preferably substantially over the entire surface area.

Additionally or alternatively, a method according to the invention is preferred, wherein the first nonwoven and/or the second nonwoven, preferably the first nonwoven and the second nonwoven, is coated with the conductive material such that the first carrier layer and/or the second carrier layer has a pattern made of the conductive material, for example a grid pattern, wherein this pattern is designed in particular such that the first carrier layer and/or the second carrier layer have a continuous conductivity sufficient for the application.

In this respect, a method according to the invention is particularly preferred, wherein the pattern of the conductive material extends over 80% or more of the surface area, preferably over 90% or more, particularly preferably over 95% or more, very particularly preferably over 98% or more, of the surface area of the first nonwoven and/or second nonwoven. It is advantageous to keep the surface area coverage of the first carrier layer and/or the second carrier layer with the conductive material comparatively low by the choice of the pattern, so that when using a coating pattern, a method according to the invention is preferred, wherein the first nonwoven and/or the second nonwoven is coated with the electrically conductive material over 60% or less of the surface area, preferably over 40% or less, particularly preferably over 30% or less. The above statements on the coating pattern apply accordingly to the design of the coating areas in step b1) if a coating pattern is used in these coating areas instead of a planar coating.

Separating the portions in method step c) is carried out with the proviso that the separating line, i.e. the cutting edge produced, for example, by shearing, runs between two spaced-apart portions of the layer composite in web form in which the second carrier layer is conductive and thus in an intermediate area in which there is no second carrier layer or in which at least no coating ensures the electrical conductivity of the second carrier layer. Accordingly, in each case the separating cut is placed during separating such that the separating line for step b1) runs between two adjacent coating areas or for step b2) between two adjacent sub-areas. In other words, separating is carried out such that the separating tool does not touch the coating areas in step b1) or the sub-areas in step b2).

This advantageously ensures that separating and the associated mechanical and/or thermal stress occur exclusively in an area in which the second carrier layer acting as an electrode is not present or at least is not conductively coated. This reliably prevents unwanted contact and/or fusion of the electrically conductive layers even at high production speeds. Accordingly, for the inherently preferred structure of the filter elements according to the invention, which rely on the advantageous use of conductive layers made of coated nonwoven and are therefore designed to be particularly light and thin while providing excellent filter performance, continuous production methods with separation from a layer composite in web form can be realized, so that a particularly time- and cost-efficient production methods can be provided. The specific design of the layer composite in web form and the positioning of the cutting areas ensure such a favorable spatial separation of the carrier layers separated by the filter layer arrangement(s) that even under the loads occurring during use in the vehicle, unwanted contact and the associated short circuit can be reliably prevented, even and especially in the case of folded, i.e. pleated filters.

In order to support this effect in a synergistic manner, according to the assessment of the inventors it is highly preferred if the nonwovens used themselves consist of an electrically insulating material and thus only become sufficiently electrically conductive through the coating. In particular in the method management with step b1), in which contact can occur in the edge area of the filter elements between the coated first carrier layer and the uncoated parts of the second carrier layer in the cutting area, a short circuit can thus be sensibly avoided even in the case of high voltages. For all embodiments, a method according to the invention is preferred, wherein the first nonwoven and/or the second nonwoven and/or the third nonwoven, preferably all nonwovens, are made of plastic, in particular electrically insulating plastic, wherein the plastic is preferably a polyester, particularly preferably polyethylene terephthalate (PET).

In order to further increase the short-circuit safety achieved in view of the optimized nature of the filter elements according to the invention at the separating edge, the inventors propose that the second carrier layer, irrespective of the method management selected in method step b), is ideally designed with a smaller width than the filter layer arrangement(s) or even than the entire first medium, so that the first carrier layer can be arranged centrally on the first medium or the overall layer arrangement. Accordingly, a method according to the invention is preferred, wherein the width of the first medium and/or the second filter layer arrangement, preferably of the first medium and the second filter layer arrangement, transversely to the web direction is greater than the width of the second carrier layer, preferably by 1% or more, particularly preferably by 2% or more, particularly preferably by 5% or more. At the same time, however, in view of the production efficiency and the fitting of the filter elements into filters, it is preferable not to make the protrusion too pronounced. Accordingly, a method according to the invention is again preferred, wherein the width of the first medium and/or the second filter layer arrangement, preferably of the first medium and the second filter layer arrangement, transversely to the web direction is greater than the width of the second carrier layer, preferably by 30% or less, particularly preferably by 15% or less, particularly preferably by 5% or less. Here, the boundaries defined above are particularly preferably combined into areas. Accordingly, a method according to the invention is also preferred, wherein the second medium is arranged on the first medium during amalgamating in method step b) such that the first medium, preferably at least the first filter layer arrangement of the first medium, projects beyond the second medium on both sides along the web direction.

Finally, the inventors have succeeded in identifying particularly favorable material parameters for the components identified above, with which particularly efficient filter elements can be obtained. Here, in particularly preferred embodiments, features of equal preference are combined in the following representations.

With regard to the desired electrical conductivity of the components, a method according to the invention is preferred, wherein, as a result of the coating, the first carrier layer has, at least partially, preferably over the entire surface area, an average electrical conductivity in the range from 10⁻² to 10⁻¹¹ 1/(Ωm), preferably in the range from 10⁻⁴ to 10⁻⁷ 1/(Ωm), and/or wherein, as a result of the coating in the coating areas, the second carrier layer in step b1) has an average electrical conductivity in the range from 10⁻² to 10⁻¹¹ 1/(Ωm), preferably in the range from 10⁻⁴ to 10⁻⁷ 1/(Ωm), and/or wherein, as a result of the coating, the second carrier layer in step b2) has, at least partially, preferably over the entire surface area, an average electrical conductivity in the range from 10⁻² to 10⁻¹¹ 1/(Ωm), preferably in the range from 10⁻⁴ to 10⁻⁷ 1/(Ωm).

To ensure a sufficient volume flow rate and an advantageously low pressure drop, a method according to the invention is preferred, wherein the first nonwoven, at 200 Pa, has an air passage in the range of 300 to 30,000 L/(m² s), preferably in the range of 2,000 to 20,000 L/(m² s), and/or wherein the second nonwoven, at 200 Pa, has an air passage in the range of 300 to 30,000 L/(m² s), preferably in the range of 2,000 to 20,000 L/(m² s), and/or wherein the third nonwoven, at 200 Pa, has an air passage in the range of 400 to 8,000 L/(m² s), preferably in the range of 500 to 6,000 L/(m² s), and/or wherein the fourth nonwoven, at 200 Pa, has an air passage in the range of 300 to 30,000 L/(m² s), preferably in the range of 2,000 to 20,000 L/(m² s).

Finally, the inventors were also able to identify suitable values for the density of the nonwovens. A method according to the invention is preferred, wherein the first nonwoven has a surface area weight in the range of 5 to 500 g/m², preferably in the range of 10 to 150 g/m², and/or wherein the second nonwoven has a surface area weight in the range of 5 to 500 g/m², preferably in the range of 10 to 150 g/m², and/or wherein the third nonwoven has a surface area weight in the range of 15 to 300 g/m², preferably in the range of 50 to 100 g/m².

The person skilled in the art will understand that the invention also relates to a filter element which is produced or can be produced using the method according to the invention, comprising:
x) a first carrier layer made of a first nonwoven coated at least partially with an electrically conductive material,
y) a second carrier layer made of a second nonwoven coated at least partially with an electrically conductive material, and
z) an overall layer arrangement arranged between the first carrier layer and the second carrier layer.

The person skilled in the art will further understand that the invention also relates to a particularly preferred specific filter element, preferably produced or producible using the method according to the invention, comprising:
x) a first carrier layer made of a first nonwoven coated at least partially with an electrically conductive material,
y) a second carrier layer made of a second nonwoven coated at least partially with an electrically conductive material,
z) an overall layer arrangement arranged between the first carrier layer and the second carrier layer,
wherein the overall filter layer arrangement comprises a first filter layer, wherein the first filter layer comprises an electrically insulating third nonwoven, and wherein the overall filter layer arrangement comprises a second filter layer, wherein the second filter layer comprises activated carbon in a mass fraction of 70% or more, based on the mass of the second filter layer.

Corresponding preferred filter elements according to the invention are characterized by very good filter performance combined with low weight and very good mechanical stability and can also be produced in a particularly time- and cost-efficient manner.

A filter element according to the invention is preferred, wherein the second carrier layer or a coating area of the second carrier layer, in which the second nonwoven is coated with an electrically conductive material, has a smaller surface area than the first filter layer, and/or wherein at least one edge of the second carrier layer or an edge of the coating area of the second carrier layer, in the plan view of the filter element, is spaced from the nearest edge of the filter layer.

Based thereon, the invention also relates to a filter comprising an air inlet and an air outlet as well as a filter element according to the invention, wherein the filter element is arranged between the air inlet and the air outlet, wherein the filter preferably comprises an integrated ionization device for ionizing particles.

Also disclosed is a device for carrying out for carrying out the method according to the invention, comprising:
o) an electronic control and regulation unit for controlling the method,
p) a first roll for providing the first medium and a second roll for providing the second medium,
q) a guide arrangement for contacting the first medium and the second medium, and
r) a separating device for separating a portion of the layer composite in web form to obtain filter elements,
as well as optionally:
s) a folding device for folding the layer composite in web form.

The invention and preferred embodiments of the invention are explained and described in more detail below with reference to accompanying figures. In the drawings:

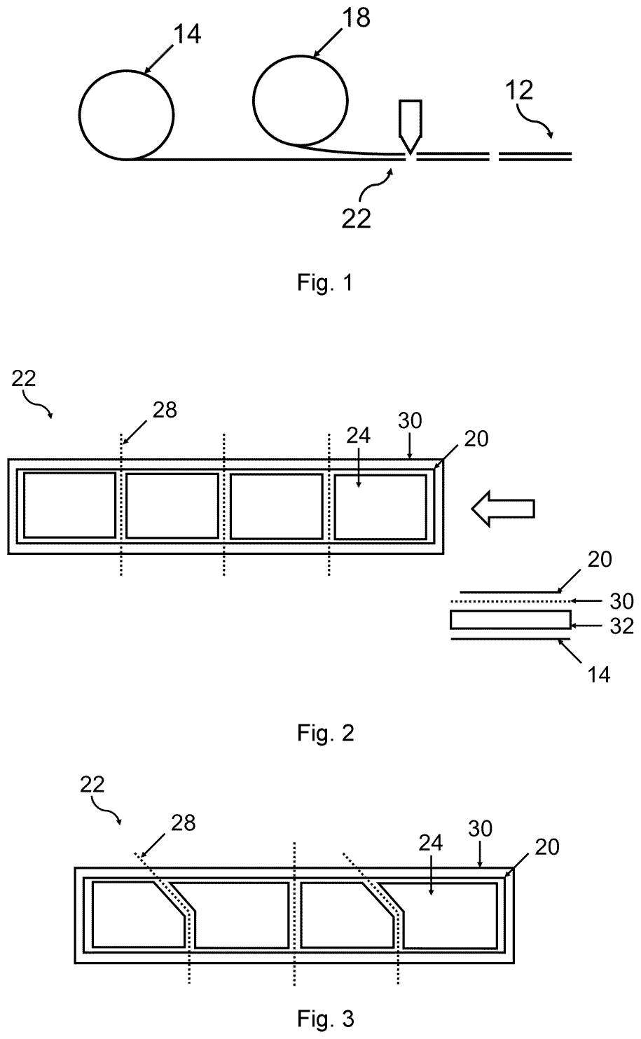

FIG. 1 is a schematic representation of a method according to the invention in a first preferred embodiment;

FIG. 2 is a schematic representation of a layer composite which can be produced using the method shown in FIG. 1, in a first preferred embodiment in plan view as well as in cross-sectional view;

FIG. 3 is a schematic representation of a layer composite which can be produced using the method shown in FIG. 1, in a second preferred embodiment in plan view;

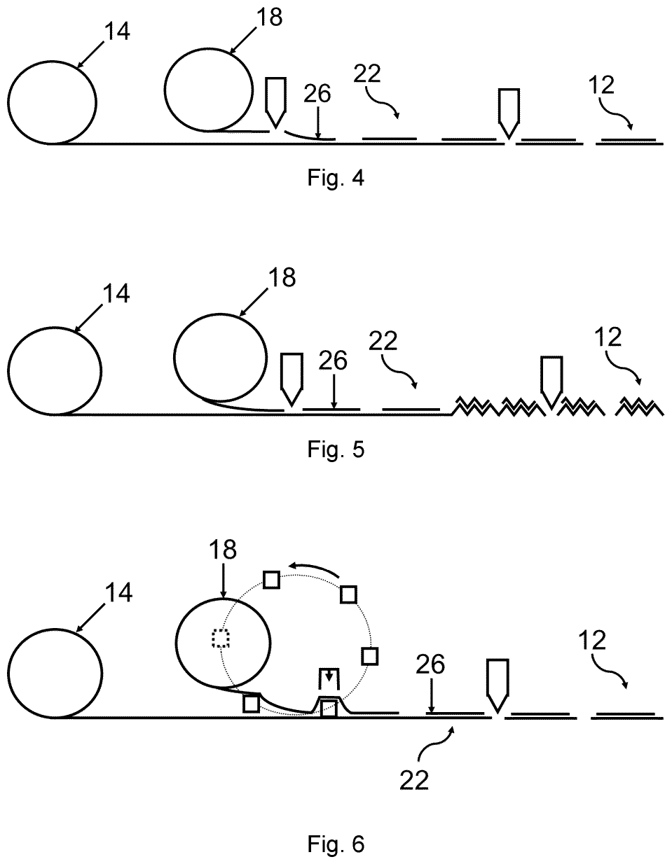

FIG. 4 is a schematic representation of the method according to the invention in a second preferred embodiment;

FIG. 5 is a schematic representation of the method according to the invention in a third preferred embodiment;

FIG. 6 is a schematic representation of the method according to the invention in a fourth preferred embodiment; and

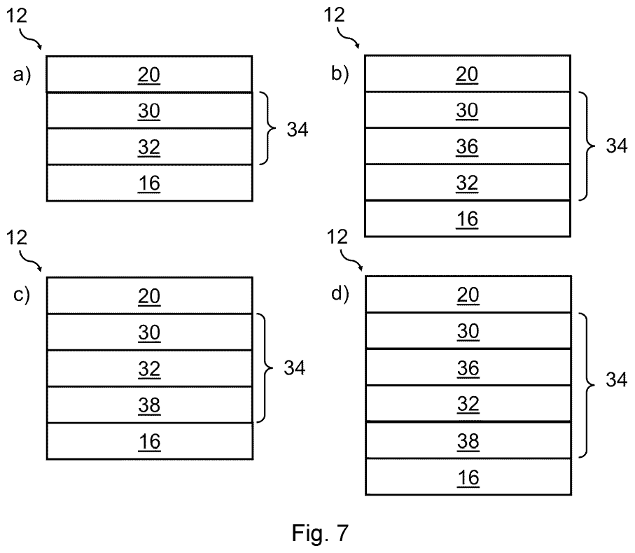

FIG. 7 is a schematic representation of a selection of preferred arrangements of layers to be used in filter elements of the method according to the invention or in filter elements according to the invention.

FIG. 1 shows a schematic representation of a method according to the invention for producing filter elements 12 in a preferred embodiment with step b1). The filter elements 12 produced by the method shown are cabin air filters for vehicles.

In the example shown, a first medium 14 in web form and a second medium 18 in web form are each provided on a material roll. The method is operated continuously and controlled and regulated by an electronic control and regulation unit (not shown).

In the example shown, the second medium 18 in web form consists of a second carrier layer 20 designed as a nonwoven, which, at 200 Pa, has an air permeability of approximately 3,000 L/(m²*s).

The first medium 14 in web form contains a first carrier layer 16, which is also formed from an electrically insulating first nonwoven, which, at 200 Pa, also has an air permeability of approximately 3,000 L/(m²*s). In addition, the first medium 14 in web form contains a first filter layer arrangement which comprises the further layers of the desired composite and accordingly has different filter layers and/or additional layers which, in view of the lack of a second filter layer arrangement in the second medium 18 in the filter element 12, will form the overall filter layer arrangement 34. This overall filter layer arrangement 34 as well as the basic structure of preferred filter elements 12 consisting of different layers are also shown in particular in FIG. 7 a-d.

In the example shown, both the first carrier layer 16 and the second carrier layer 20 are coated with an electrically conductive material, which in this case is carbon black. Here, the first carrier layer 16 is substantially coated over its entire surface area, whereas the second carrier layer 20, in order to implement the method management according to FIG. 1, only partially has a coating in the so-called coating areas 24, which are spaced apart from one another along the web direction. In the coating areas 24, the second carrier layer 20 is coated over its entire surface area with carbon black, for example by spatially resolved coating, in particular printing. By spacing the coating areas 24 from one another along the web direction of the layer composite 22, intermediate areas are created in which the second carrier layer 20 is not electrically conductive.

In the example shown, the first medium 14 and the second medium 18 are connected to one another in a materially bonding manner with an adhesive after being unrolled from the respective material roll. In the embodiment shown, the first medium 14 and the second medium 18 are amalgamated by the two material rolls running substantially synchronously, so that the arrangement of the first medium 14 over the second medium 18 results in a layer composite 22, as shown in FIGS. 2 and 3.

By separating portions along the uncoated intermediate areas, the layer composite 22 can be cut to length to obtain the filter element 12. This advantageously ensures that separating and the associated mechanical and/or thermal stress occur exclusively in an area in which the second carrier layer 20 acting as an electrode is not conductively coated.

FIG. 2 shows a layer composite 22 produced by means of the method shown in FIG. 1 in plan view, as well as a cross-sectional view of this layer composite 22 as seen from the direction of the arrow shown, which visualizes the structure thereof transverse to the web direction.

In the example shown, the overall filter layer arrangement 34 consists of a first filter layer 30 as well as a second filter layer 32 and not only spatially separates the first carrier layer 16 and the second carrier layer 20, but also acts as electrical insulation between the carrier layers, cf. in this respect also FIG. 7a-d. In order to additionally reduce the risk of a short circuit between the conductive areas of the first carrier layer 16 and the second carrier layer 20, the second carrier layer 20 is designed with a reduced width compared to the layers of the first medium 14, i.e. compared to the first carrier layer 14, the first filter layer 30 and the second filter layer 32.

As described above, filter elements 12 can be obtained from the layer composite 22 in web form by dividing the layer composite 22 along the separating line 28 into individual filter elements 12, wherein the separating lines 28 are arranged in the intermediate areas, i.e. between the coating areas 24. As shown in FIG. 3, different geometric shapes of the filter element 12 can also be produced by means of the method by matching the shape of the coating areas 24 to the shape of the subsequent filter elements 12. Insofar, for example, oblique contours and edges in the filter element 12 can already be anticipated via the coating areas 24.

FIGS. 4 to 6 each show schematic representations of the method according to the invention in further preferred embodiments with step b2). The methods shown differ in particular from the method management shown in FIG. 1 in that the second medium 18 or its second carrier layer 20 and the second nonwoven comprised by this second carrier layer 20 do not comprise any coating areas 24 in the ways of method management shown, and are separated in the method into sub-areas 26 which are arranged at a distance from one another on the first medium 14 in web form such that in this structure too a layer composite 22 is obtained which has no electrically conductive connection between portions of the second medium 18 which are spatially separated along the web direction. In this respect, it is advantageously possible in this method management to form the second medium 18 from a second carrier layer 20 coated over its entire surface area.

As shown in FIGS. 5 and 6, dividing the second medium 18 into sub-areas 26 can in principle be carried out without waste by means of a chipless separation process. Here, the spaced arrangement of the sub-areas 26 can be made possible by different feed speeds of the media in web form, for example by a reduced speed and/or a discontinuous timing of the second medium 18 relative to the first medium 14.

As shown in FIG. 7, dividing the sub-areas 26 can also be carried out by removing a waste area between the sub-areas 26. In this case, the method management can create a distance between the sub-areas 26 at the same feed speed of the material rolls of the first medium 14 and the second medium 18 due to the waste area removed. In the example shown in FIG. 7, this waste area is realized by a circularly rotating carriage arrangement and a separating tool, wherein the carriage locally lifts the second medium 18 at predetermined intervals and guides it against the separating tool in order to cut out the waste area.

In principle, dividing the second medium 18 into sub-areas 26, as shown in FIGS. 4 and 6, can be carried out before amalgamating the first medium 14 and the second medium 18. However, as shown in FIG. 5, it is also possible to separate the sub-areas 26 only after they have been amalgamated.

As already described above for the method shown in FIG. 1, the final production of the filter elements 12 is carried out by separating portions from the layer composite 22 in web form by means of a separating device. During separating, the separating cut is placed such that the separating line 28 between two adjacent sub-areas 26 runs such that separating takes place in an area in which the second carrier layer 20 acting as an electrode is not present. If a pleated filter element 12 is to be produced, as indicated in FIG. 5 and as is explicitly preferred for each of the methods shown here, the folding step can take place before, during or after the separation.

In FIG. 7, arrangements of filter elements 12 produced by means of the method according to the invention or of preferred filter elements 12 according to the invention are shown. In all embodiments a) to d) shown, the overall filter layer arrangement 34 comprises at least the first filter layer 30 consisting of a third nonwoven and the second filter layer 32 containing granular activated carbon, wherein the activated carbon has, for example, a specific surface area of 2000 m²/g or more and substantially comprises no fibrous materials. In the example shown, the activated carbon layer consists of about 200 g/m² of activated carbon, which is mixed with about 15 g/m² of binding agent.

It is also preferred to provide a first additional layer 36 containing a third nonwoven, which is arranged, for example, between the first filter layer 30 and the second filter layer 32, as shown in FIG. 7b), but which can alternatively also be placed at other locations, for example between the second carrier layer 20 and the first filter layer 30. Additionally or alternatively, a second additional layer 38 can be provided which comprises a fourth nonwoven and which is arranged between the first carrier layer 16 and the second filter layer 32, as shown in FIG. 7c) or FIG. 7d). In any of the embodiments of the filter element 12 described above, it is also explicitly preferred if the overall filter layer arrangement 34 comprises at least a first protective layer (not shown) which contains antiallergenic active ingredients and/or biocidal active ingredients.

### LIST OF REFERENCE SIGNS

12 filter element
14 first medium
16 first carrier layer
18 second medium
20 second carrier layer
22 layer composite
24 coating area
26 sub-area
28 separating line
30 first filter layer
32 second filter layer
34 overall filter layer arrangement
36 first additional layer
38 second additional layer

1. A method for producing a filter element, in particular for use in electrostatic separators, the method comprising:
producing or providing a planar first medium in web form, having a first carrier layer that comprises a first nonwoven fabric at least partially coated with an electrically conductive material, and producing or providing a planar second medium in web form, having a second carrier layer that comprises a second nonwoven fabric at least partially coated with an electrically conductive material,
wherein one or more of: the first medium comprises a first filter layer arrangement connected to the first carrier layer; and the second medium comprises a second filter layer arrangement connected to the second carrier layer,
amalgamating the first medium and the second medium to obtain a layer composite in web form, the amalgamation taking place such that one or more of the first filter layer arrangement and the second filter layer arrangement are at least partially arranged between the first carrier layer and the second carrier layer, and
separating a portion of the layer composite in web form to obtain the filter element comprising a part of the first carrier layer and the second carrier layer and comprising one or more of the first filter layer arrangement and the second filter layer arrangement,
wherein the amalgamating comprises one of:
applying the second medium in web form to the first medium in web form, wherein the second carrier layer comprises a plurality of coating areas spaced apart from one another along the web direction of the layer composite, in which the second nonwoven fabric is coated with the electrically conductive material, or
dividing the second medium in web form to obtain a plurality of sub-areas, the amalgamation taking place such that the sub-areas are spaced apart from one another along the web direction of the layer composite, the second nonwoven fabric of the second carrier layer being at least partially coated with the electrically conductive material in the sub-areas, and
wherein separating a portion of the layer composite in web form is carried out such that the separating line runs between two adjacent coating areas or two adjacent sub-areas.

2. The method according to claim 1, wherein the method is a continuous or semi-continuous method.

3. The method according to claim 1, wherein one or more of the first filter layer arrangement and the second filter layer arrangement comprise a first filter layer, wherein the first filter layer comprises an electrically insulating third nonwoven fabric.

4. The method according to claim 1, wherein one or more of the first filter layer arrangement and the second filter layer arrangement comprise a second filter layer, wherein the second filter layer comprises activated carbon in a mass fraction of 70% or more, based on the mass of the second filter layer.

5. The method according to claim 1, wherein the filter element is produced as a pleated filter element,
wherein, prior to separating the portions, the layer composite in web form is folded at least partially, or
wherein, after separating, the separated portion of the layer composite in web form is folded at least partially.

6. The method according to claim 1, wherein separating the portion of the layer composite in web form is carried out by a process selected from a group consisting of cutting, punching and welding methods.

7. The method according to claim 1, wherein the width of the first medium transverse to the web direction is greater than the width of the second medium.

8. The method according to claim 1, wherein the plurality of coating areas are created by one or more of spatially resolved coating, and local printing, of the second nonwoven fabric.

9. The method according to claim 1, wherein the plurality of coating areas in the second carrier layer along the web direction of the layer composite each have a distance in a range of one or more of 0.01*L to 0.1*L, and 0.02*L to 0.05*L, from adjacent coating areas, where L is the average length of the adjacent coating areas along the web direction of the layer composite.

10. The method according to claim 1, wherein the second nonwoven fabric of the second carrier layer is coated with the electrically conductive material over 80% or more of the surface area.

11. The method according to claim 1, when dividing between the sub-areas, substantially no waste area of the second medium is removed,
wherein the division is carried out by one or more of a chipless separation process and a cutting process,
wherein the spacing of the sub-areas on the first medium in web form is at least in part achieved by guiding the second medium at one or more of a reduced speed and with a discontinuous timing.

12. The method according to claim 1, wherein dividing of the second medium is carried out such that when dividing between the sub-areas, a waste area of the second medium is removed, wherein the spacing of the sub-areas on the first medium in web form is at least in part created by the waste areas, wherein the second medium is guided at substantially the same speed relative to the first medium.

13. A filter element, produced or producible by the method according to claim 1, the filter element comprising:
a first carrier layer made of a first nonwoven fabric at least partially coated with an electrically conductive material,
a second carrier layer made of a second nonwoven fabric at least partially coated with an electrically conductive material,
an overall filter layer arrangement arranged between the first carrier layer and the second carrier layer,
wherein the overall filter layer arrangement comprises a first filter layer, wherein the first filter layer comprises an electrically insulating third nonwoven fabric, and wherein the overall filter layer arrangement comprises a second filter layer, wherein the second filter layer comprises activated carbon in a mass fraction of 70% or more, based on the mass of the second filter layer.

14. A filter comprising: an air inlet and an air outlet; and the filter element according to claim 13, wherein the filter element is arranged between the air inlet and the air outlet, wherein the filter comprises an integrated ionization device for ionizing particles.
